(19) United States
(12) Patent Application Publication
(10) Pub. No.: US 2004/0055211 A1
(43) Pub. Date: Mar. 25, 2004

(54) Single seed sortation

(76) Inventors: Torbjorn Lestander, Umea (SE); Per Oden, Umea (SE)

Correspondence Address: PILLSBURY WINTHROP, LLP, P.O. BOX 10500, MCLEAN, VA, 22102, US

(21) Appl. No.: 10/296,499

(22) PCT Filed: May 23, 2001
(86) PCT No.: PCT/SE01/01170

(30) Foreign Application Priority Data
May 25, 2000 (SE) 0001967-9

(51) Int. Cl. A01C 1/00

(52) U.S. Cl. 47/14

(57) ABSTRACT

A method to determine viability or non-viability of seeds is disclosed, wherein individual seeds or seed populations are analysed by a spectrometric method to provide spectral data; and said spectral data are compared with reference spectral data obtained for a reference seed or reference seed population by means of said spectrometric method and calibrated with reference to viability or non-viability of said reference seed or seed population by means of a calibrating method based on pattern recognition. Suitable calibrating methods are based on multivariate or megavariate analysis, neural network systems and regression analysis.

The present invention is concerned with a method to sort seed according to specific properties of individual seeds, and more specifically to sort seeds in separate fractions comprised of viable and non-viable seeds, respectively.

Since seeds constitute extremely valuable commercial products and high values are lost if the seed used for seeding is of inferior quality, seed improvement has constantly been aimed at, not only by sorting seed but also by traditional genetic selection and plant improvement. Moreover, in recent years, methods for plant improvement based on recombinant DNA technology have gained more and more interest.

To achieve seed of high quality, it is of course important that essentially all or at least a high number of individual seeds in a seed population intended for seeding exhibit the desired properties.

Various methods have been used to sort seed on the basis of different properties of individual seeds. Such methods have been based on principles allowing measurement of physical characteristics, such as colour, size, shape and specific density, and subsequent sorting of the seed in accordance with said characteristics. Recently, also the chemical content of seed, i.e. proteins, starch, lipids, etc. has been used as sorting principle.

Various methods to sort seed are thus previously known. For instance, sizing based on use of sieves comprising apertures designed to size on length, width and height, respectively, is previously known. Gravity and sedimentation have also been used to obtain seed fractions, e.g. in air or liquid currents.

Spectrometric methods utilizing X-rays have been used since long to correlate various properties of seed, including not only true properties of the seed but also possible content of parasitic forms inside infested individual seeds, to certain spectral parameters.

Such spectrometric methods have also been performed in visible light (VIS), near-infrared (NIR) or the ultraviolet (UV) region or as X-ray transmission and may comprise a pretreatment of seed, e.g. with a biochemical marker (Taylor et al. 1993).

In general, such spectrometric methods have only been adapted to correlate physical and chemical properties. For instance, certified and standardized NIR-methods for prediction of the protein content in samples of wheat kernels do exist (Anon., 1982 AACC Method 39-10 Near Infrared Reflectance. Method for Protein Determination. In: Approved Methods of the American Association of Cereal Chemists, American Association of Cereal Chemists Inc., St. Paul, Minn., U.S.A.). Germination capacity is another property, that has been shown to be correlated to NIR-spectra although at various rates of correlation.

In WO 82/02470 electrical characteristics of the individual seeds are correlated to their germinative capability and, thus, viability and in WO 85/00656 moisture of individual seeds are measured by means of an electroluminescent sensor.

Another property that has been studied for use in liquids to separate viable and non-viable seeds is the different rate for loss of adsorbed water that is obtained for viable and non-viable seeds, respectively, after imbibing non-dormant seeds with water, non-viable seeds losing in average more water than viable seeds (U.S. Pat. No. 4,467,560 to Simak, M.).

From the above it is evident that although there have been attempts to sort seeds upon different characteristics, frequently such characteristics only comprise physical and chemical characteristics and moreover, the success, i.e. accuracy, has been limited. Apparently, there is a need for an improved method that enables sorting on biological properties, such as viability.

Even though some prior art methods have been designed to sort out non-viable seeds from a seed population, such methods are hampered by low accuracy.

Accordingly, it is an object of the present invention to provide a method wherein seeds, seed by seed or as a seed population, can be divided in two distinct fractions, one fraction being comprised of viable and the other of non-viable seeds, which method can be performed as automatic single seeds separation of viable and non-viable seeds or as automatic separation of viable and non-viable seeds in a seed population.

This object is achieved with a method according to the present invention wherein

(1) an individual seed or a seed population is analysed by a spectrometric method to provide spectral data; and

(2) the spectral data measured in (1) are compared with reference spectral data measured for a reference seed or reference seed population with the spectrometric method of (1) and calibrated with reference to viability or non viability of said reference seed or seed population by means of a calibrating method based on pattern recognition, or said data are compared with reference spectral data from a data base.

According to a suitable embodiment of the present invention, the seeds are pretreated with water, i.e. seeds are first moistured to take up a small amount (i.e. 10-80% of their own weight) of water and then dried before entered in step (1) so that the spectral data of step (1) are obtained in the drying process of pretreated seeds. When analysing pretreated seeds, the moisture content is at least 2% and suitably within a range of 2-70% (based on fresh weight) and preferably 4-50%. Although the present invention is mainly focused on sorting filled whole single seeds that are intact or non-damaged, a further embodiment of the present invention is concerned with sorting out particles, such as pitch or resins, similar to seeds from a seed population, said particles having i.a. essentially the same density and size as the seeds, and also other outliers. Such particles could also comprise empty seeds or damaged seeds.

Thus, according to the present invention the expression “seed” may in connection with spectral data also comprise “seed like particles”.

A “seed population” is defined as comprising multiple seeds (i.e. more than one seed) from the same species, which seeds may have some property, such as size, origin, etc., in common. Usually, a seed population comprises at least about 25 individual seeds.

Seeds that can be analysed according to the present invention are seeds from virtually all common plants. For instance, seeds from conifers, such as spruce, fir, larch and pine; broad-leaved trees, such as birch, oak, beech and maple; grains, such as wheat, barley, corn, oat, rye, rape, beans, peas, sunflower, sugar beets, and rice; ornamental plants, such as pelargonium and tobacco; and kitchen-garden plants, such as beans, tomatoes, lettuce, onion, parsley, dill, carrots and cabbage, illustrate suitable seeds.

The expression “seed” is also intended to encompass reproductive structures like single seed fruits, nuts, caryops, grains and kernels. Moreover, the present methods are developed to fit both orthodox seeds and recalcitrant seeds.

Suitably, the spectrometric method used for analysis in step (1) is performed at at least one, and preferably at multiple wavelengths in the range of 180-50,000 nm, suitably 400-2500 nm, specifically 560-1100 nm or 1100-2400 nm and preferably 850-1050 nm. A suitable range for NIR is 740-1960 nm or one or more wavelengths covering the absorption peaks of water at about 760, 970, 1450 and 1940 nm.

Thus, the spectrometric method used in the present method to analyse a single seed or a seed population is suitably performed in the near infrared spectrum (NIR) (from about 770 nm) and preferably as reflectance or transmittance spectroscopy.

According to another embodiment of the present invention, the spectrometric method used step (1) is performed in the wavelength range that extends from ultraviolet (UV) through visual (VIS) and NIR to infrared (IR), viz. from about 180 to about 1,000,000 nm, and could be performed as absorption, reflectance, emission or transmission spectroscopy.

In a suitable spectroscopic method for use in step (1) of the present method, either radiation absorbed or radiation reflected or transmitted by the seed or seed population is measured. For instance, transmission spectroscopy suitably comprises complete or partial radiation transmission through seeds and reflectance spectroscopy is used to measure radiation reflected from seed.

As stated above, an essential feature of the present method is that measured values are compared with reference values that have been calibrated to viability or non-viability of a seed by means of a calibrating method based on pattern recognition. Multivariate and megavariate calibration, neural network (NN) systems and support vector machines (SVM) and also regression analysis illustrate useful calibrating methods providing global or local models. In addition K Nearest Neighbours (KNN) and Linear Discriminant Analysis (LDA) are suitable methods.

According to a suitable embodiment of the present method, calibrating is based on multivariate data analysis. Such analysis is suitably performed by means of partial least squares projection to latent structures (PLS), principal components regression (PCR), principal components analysis (PCA), canonical correlation, multilinear regression analysis (MLR), multiresponse ridge regression, discriminant analysis, factor analysis, or a combination thereof. Neural network (NN) systems and regression analysis are further suitable calibrating methods, as support vector machines. Also artificial intelligence (AI) systems could be used to perform the data analysis, optionally in combination with neural network systems. Cristianini, N. & Shawe-Taylor, J. 2000. An introduction to Support Vector Machines (SVM) and other kernel-based learning methods. Camebridge University Press, Cambridge, UK. ISBN 0-521-78019-5. Another suitable method is based on radial bases neural networks.

Further suitable method for multivariate data analysis are PLSR and PLS in combination with PLS-DA as mentioned further below.

To provide spectral data for a seed or seed population, virtually any existing spectrometer could be used. Such spectrometers are commercially available, e.g. 1225 Infratec Anaylzer from Foss Tecator, Sweden, and NIRSystem 6500 from NIRSystem Inc. USA, which when used for single seed measurements suitably is provided with a Single Seed Adapter or a special device.

In the spectrometer used in the present method, the light is converted into an electric signal which is then conveyed to a computer where the spectrum (optionally compressed) of a previously stored reference scan is related to the sample spectrum to calculate a reference corrected spectrum.

Suitably, however, transformation of spectra is performed prior to mathematical build-up of the calibration models.

For instance, standard normal variate (SNV) according to Barnes et al. (1989) and multiplicative scatter correction (MSC) according to Geladi et al. 1985 could be used to remove scatter effects. Also 1^{st} and 2^{nd} derivative according to Savitzky and Gulay (1964) (software package Unscrambler 7.5 (Copyright: Camo ASA, Norway)) could be used to remove influence due to off-set and base line, respectively. Orthogonal signal correction (OSC) according to Wold et al. (1998) is useful for reducing influence of non-relevant information structure in the spectra on the calibration models. Suitably, only one transmission method is applied in each different calibration model.

It is convenient that the detector of the spectrometer provides measuring intervals of, for instance 10 nm, specifically 2 nm, and preferably 1 nm or less. The detection can be performed in the UV-VIS-NIR-IR wavelength range of 180 nm to 50,000 nm. This is suitably accomplished by the use of a scanning instrument, a diode array instrument, a Fourier transform instrument, tunable laser, or any other similar equipment known to a person skilled in the art.

In some embodiments of the invention, the spectrometric method is accomplished by means of an image-generating device, such as for instance an image-generating NIR device or a colour video camera or/and in combination with image analysis, for instance based on multivariate calibration.

An evaluation of wavelengths with regard to absorption reflectance or transmission will provide features relevant for the analysis. By the application of the calibrating methods of the present invention to the obtained spectra, it is possible to ignore wavelengths which do not contain information that contributes to the analysis, even though the measured data will include information from the entire wavelength range. It is also possible to add non spectroscopic data that could provide some information to the training set.

According to one embodiment, the present method comprises the steps of

I) providing a data base by

(I.a) registering, by means of a spectrometric method, reference spectral raw data of a reference seed or reference seed population;

(I.b) processing the reference spectral raw data to reduce noise and adjust for drift and diffuse light scatter;

(I.c) providing global and local calibration models by calibrating the processed reference spectral data with reference to the known viability or non-viability of the reference seeds by performing a data analysis based on pattern recognition, such as multivariate or megavariate analysis, PLA, PLS, NN, LDA and support vector machines; and

(II) registering, by means of said spectrometric method, spectral raw data of a sample seed or sample seed population for which viability or non-viability is to be determined; processing the thereby obtained spectral raw data to reduce noise and adjust for drift and diffuse light scatter, and applying the provided or established global or local calibration models on the processed spectral data in order to determine viability or non-viability of the sample seed or sample seed population or use direct methods like KNN. Thus, this method could also be performed as a direct comparison with the data base without calibration of data as in step (I.c).

The data analysis, e.g. multivariate analysis, in sub-step (I.c) preferably includes transferring the processed reference spectral data into latent variables; and in sub-step (II) the processed spectral data are preferably transferred into latent variables as in (I.c), and the provided calibration model is applied on the latent variables in order to determine the unknown condition (viability/non-viability). Principal least squares regression (PLSR) or projections to latent structures (PLS) in combination with discriminant analysis (PLS-DA) for cclassification are suitably also used as calibration techniques. The processed spectral data can also be transfered into non-linear data by sigmoide functions prior to NN-calibration or into kernel-based vectors provided for SVM-calibration.

I. Development of a Global or Local Calibration Model

The viability/non-viability condition is determined in a traditional way for a number of single reference seeds or reference seed populations. This information is then used to provide or establish a calibration model wherein the three sub-steps discussed below are applied to the registered absorption, reflectance or transmission spectra of said reference seeds or reference seed populations.

(I.a) Development of Calibration Sets

Model calibration sets consist of a large number of absorption reflectance or transmission spectra from the reference seeds or seed populations of known viability/non-viability.

(I.b) Data Processing

To reduce noise and adjust for base line drift, the spectral raw data are suitably processed. This processing could also reveal hidden information, such as identity of apparently dissimilar spectra, or non-identity of apparently very similar spectra. Moreover, the assumptions leading to Beer's law (stating that, for a given absorption coefficient and length of the optical path in the absorptive media, the total amount of light absorbed is proportional to the molecular concentration of the sample) are not always fulfilled in the complex system that the samples constitute. This is due to a number of factors, often found in industrial and laboratory samples. Another complicating factor is light scattering variations depending on particles in the sample. Various theories have been developed to overcome this problem and those most frequently used are: the Kubelka-Munk transformation, that accounts for absorption and scatter; and the Multiplicative Scatter Correction, where each spectrum is corrected in both offset and slope by comparing it to an ‘ideal’ spectrum (the mean spectrum). Another way of linearising the spectral data is by use of derivatives, e.g. up to the fourth order derivatives (A. Savitzky, M. J. E. Golay, Anal. Chem. 36, 1627-1639 (1964), incorporated herein by reference). The derivative of the spectrum results in a transformed spectrum, consisting only of the relative changes between the adjacent wavelengths, and it has been shown that the peak intensities of derived spectra tend to be more linear with concentration (T. C. O'Haver, T. Begley, Anal. Chem. 53, 1876 (1981). Linearisation can also be accomplished by use of the Fourier transformation, or by use of the Standard Normal Variate transformation as disclosed in R. J. Barnes, M. S. Dhanoa and S. J. Lister, Appl. Spectrosc., Vol. 43, number 5, pp. 772-777 (1989). Another useful method, Orthogonal Signal Correction (OSC), is described by Svanto Wold et al in “Chemometrics and Intelligent Laboratory Systems 44 (1998), pp 175-185. Data compression, as wavelet, is disclosed in Strang, G. & Nguyen, T. 1996. Wavelets and Filter Banks. Wellesley Cambridge Press, MA, USA, ISBN 0-9614088-1.

(I.c) Data Analysis

Data analysis according to the invention, e.g. based on multivariate techniques, then allows the calibration model to be developed. There are several multivariate or other techniques that can be used, such as PCA, PLS, PCR, MLR, and Discriminant Analysis. Neural network systems, support vector mashines and/or artificial intelligence systems could also be used to carry out the analysis, in particular if the spectrometric method involves or is combined with image analysis.

(II) Determination by Application of the Calibration Model.

Once a calibration model has been provided, the determination of the unknown condition (viability/non-viability) of the seed sample can be performed by registering the absorption or transmission spectrum, in correspondence with (I.a); processing the thereby obtained spectral raw data as in (I.b); optionally performing a data analysis on the processed spectral data as in (I.c); and applying the provided or established calibration model to the thereby obtained data.

(III) Determination by Direct Comparison Neighbour-Neighbours

A direct comparison between seed sample values and reference data in a database can be performed without any intervening calibration of reference data. Suitably, data analysis is based on K nearest neighbours where K=1-50.

In the following experimental part, the present invention is illustrated with reference to suitable embodiments thereof. These embodiments are explained in detail with reference to the drawings, where

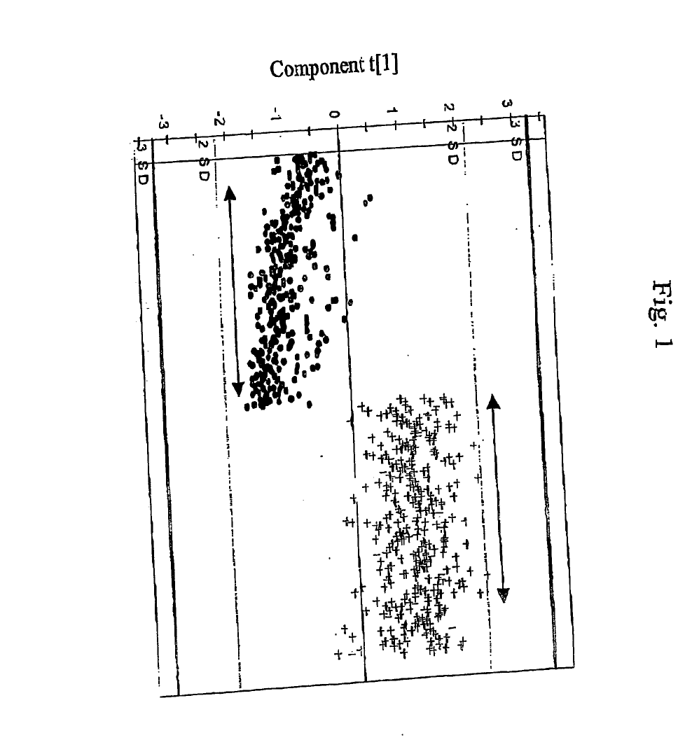

FIG. 1 shows treatment effects reflected in the single PLS component showing viable seeds (+) and non-viable seeds (*). The interval from left to right (indicated by arrows) within each seed-class spans from 0.8 h drying time to 3.8 h.

FIG. 2 shows variable importance in different PLS-models reflecting the correlation to all factors in the single model.

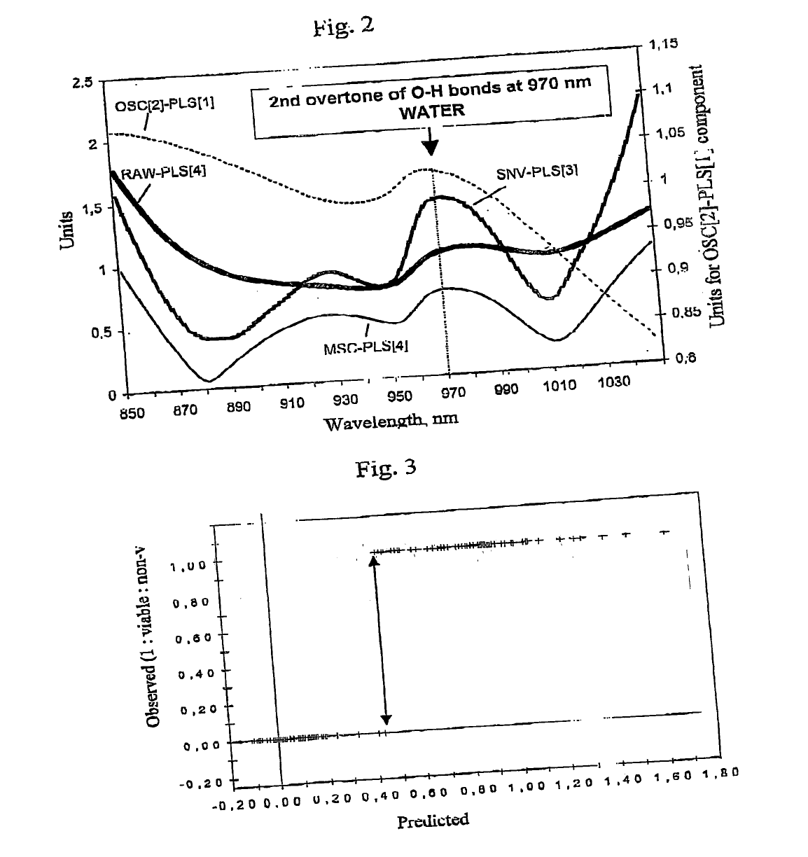

FIG. 3 shows observed and predicted values of test set with no overlap in prediction values. Complete separation of viable (class-value 1.00) and non-viable (class-value 0.00) seeds in test set using MSC-PLS multivariate calibration model based on single seed NIR transmittance spectroscopy.

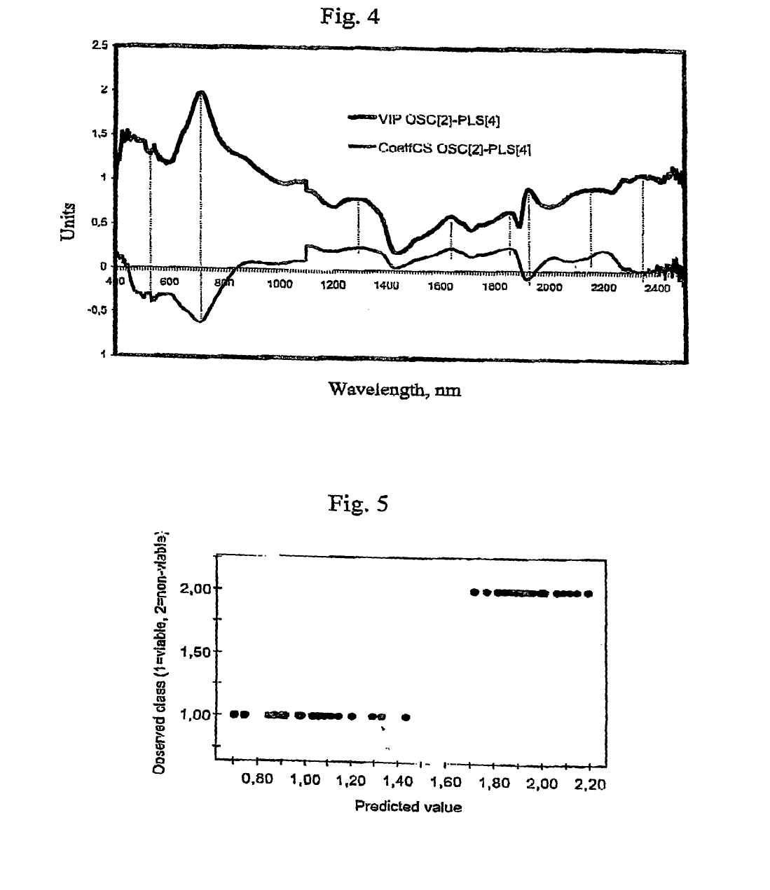

FIG. 4 shows variable importance (VIP) and influence of the spectra on seed-class (reflected by CoeffCS) in an OSC-PLS multivariate calibration model based on single seed reflectance at 400-2500 nm from storage dry viable and non-viable seeds.

FIG. 5 shows predicted vs. observed quality class of viable and non-viable seeds by a multivariate calibration model. Results from prediction of a validation set of viable and non-viable dry seeds by a multivariate OSC[2]-PLS[3] calibration model based on single seed NIR reflectance at 400-2500 nm are shown.

### EXAMPLE 1

### Drying of Moist Viable and Non-viable Seeds

Viable and non-viable Scots pine (Pinus sylvestris L.) seeds were inbibed to 30% moisture content for 4 days at 15° C. and nearly 100% air humidity. Calibration models were based on single seed near infrared (NIR) transmittance spectra (368 spectral observations in each class single seed near infrared (NIR) transmittance spectra (368 spectral observations in each class of viable or non-viable seeds) at 850-1050 nm collected during seed drying 0.8-3.8 hrs at 25° C. and about 40% air humidity. Calibration models were done by neural networks, multivariate calibration, discriminant analysis or k nearest neighbours to classify viable seeds from non-viable seeds. An independent test set, simulating a seed lot, was used to find out the ability of different classification methods and models to predict, from only the information of single seed spectra, the quality class of every single seed. The test set consisting of viable and non-viable seeds, in total 129 seeds, was pre-treated in the same way and dried at corresponding conditions for 2 hrs when single seed transmission spectra were collected. The calibration sets were spanning over a broad drying interval in order to increase the significant model space and thus surround the variable space of the test set. The single seed NIR spectra were then run through the different calibration models. As is evident from Table 1, the highest predication accuracy of viable and non-viable seeds in the test set was achieved by using neural networks (NN) and projections to latent structures (PLS).

Classification methods, like neural networks and multivariate calibration among others, based on single seed near infrared transmittance at 850-1050 nm showed high prediction accuracy (98.4-100%, Table 1) as regards characterisation and thereby separation ion of viable and non-viable seeds of Scots pine (Pinus sylvestris L.). These high prediction rates were also evident when using different compression methods of data (Wavelets, PCA) and transformation of data by for instance multiplicative scatter correction (MCS), standard normal variate (SNV), 1^{st} and 2^{nd} order derivatives and orthogonal signal correction (OSC). Even linear discriminant analysis (LDA) and simple classification methods like k nearest neighbours (KNN) showed high accuracy (92.3-98.4%) as is evident from Table 1.

TABLE 1
Classification accuracy by some classification and calibration methods.

| | | | | Classi- |
|---|---|---|---|---|
| | | | | fication |
| Classification | Compression | Transforma- | Components or | accuracy, |
| Method | of data | tion of data | hidden nodes | % |
| SVM | PCA 4 | Kernel | 10 vectors | 99.2 |
| NN 80-20 | PCA | Sigmoide | 10 nodes | 100 |
| NN 80-20 | PCA 6 | Sigmoide | 12 nodes | 100 |
| NN 80-20 | Wavelets 16 | Sigmoide | 16 nodes | 100 |
| PLS | None | None | 4 components | 99.2 |
| PLS | None | 1^{st} | 3 components | 98.4 |
| | | Derivative | | |
| PLS | None | 2^{nd} | 2 components | 98.4 |
| | | Derivative | | |
| PLS | None | MSC | 4 components | 100 |
| PLS | None | SNV | 3 components | 99.2 |
| PLS | None | OSC | 1 component | 99.2 |
| PCA | — | OSC | 2 components | 99.2 |
| LDA | — | None | — | 98.4 |
| KNN (:1-3) | None | None | — | 92.3 |
| KNN (K:1-3) | PCA 4 | None | — | 92.3 |
| KNN (K:1-3) | PCA 6 | None | — | 92.3 |

In this example, the influence of the experimental design was so high that even in score plots of OSC-PCA-models there were a clear tendency to separate spectra according to the classifying in viable and non-viable seeds. This effect was further accented in all the PLS-models. A good example was the only significant (p≦0.5) OSC-PLS component, (see FIG. 1), which showed a very clear effect of drying time of non-viable seeds. FIG. 1 also indicates that in this case it was even more beneficial to dry seeds for a longer time period than the 2 hrs drying period applied to the viable and non-viable seeds in the test set. An analysis of the variable importance within PLS models showed the influence of the drying treatment of the calibration set (FIG. 2). The models responded to the peak of water at 970 nm, but a high influence is also found at the ends of the wavelength interval, indicating that other factors at these wavelengths also influence the models.

Prediction of the seeds in the test set, using neural networks or MSC-PLS, showed the highest possible prediction ability, viz. 100%. An example is the result using MSC-PLS (FIG. 3). Which showed no overlapping between viable and non-viable seeds.

### EXAMPLE 2

### Separation of Dry Viable and Non-viable Seeds

Single seed NIR reflectance spectra from storage dry (taken directly from storage) viable and non-viable single Scots pine seeds were collected at 400-2500 nm against a black background. A calibration set of viable and non-viable seeds was used as in example 1 to model the spectra according to their quality class by classification methods. Only one model example is shown, viz. an OSC[2]-PLS[3] calibration model, among others (see example 1). A separate set of single seed NIR reflectance spectra were used for validation of the model. This example is based on 50 seeds in each class and has a root mean square error of estimation of 0.163. The variable importance showed the highest influence on the model at 650-850 nm (see FIG. 4).

The predicted quality-class of the seeds in the validation set was very accurate, viz. 100%, and this shows the potential to completely separate non-viable seeds from viable seeds, even when storage dry, by using spectroscopic reflectance in UV/VIS/NIR/IR besides transmission.

FIG. 4 indicates broad peaks that are of interest within the VIS/NIR-region, but also regions with low absorption, to classify viable and non-viable seeds. Different phytochromes are for example active at 600-700 nm and this could perhaps explain some of the peaks at this wavelength region, but there is limited knowledge of phytochrome responses in storage dry seeds, especially in conifers. But in some angiosperms, phytochromes are even visible for eye e.g. in peas (Pisum sativum). Deterioration processes like oxidation could also be involved and explain the good prediction accuracy and low calibration model errors.

By PLS-modelling it is possible to completely separate viable from non-viable seeds, (see FIG. 5). Other methods than multivariate calibration (see example 1) to classify seeds according to spectroscopic data from single seeds, like neural networks (NN), KNN (k nearest neighbours), discriminant analysis (DA) etc. can also be used (see for example text books: Vapnik, V. N. 1998. Statistical learning theory, Wiley & Sons, Inc. N.Y., USA, ISBN 0-471-03003-I; Diamanlaras, K. I. & Kung, S. Y. 1996. Principal component neural networks: theory and appplications. Wiley & Sons, Inc. N.Y., USA, ISBN 0-471-05436-4; Martens, H. and Naes, T. 1989. Multivariate Calibration, John Wiley & Sons Ltd, Chichester, GB, ISBN 0-471-90979-3, 419 pp; Eriksson, L., Johansson, E., Kettaneh-Wold, K. And Wold, S. 1999. Introduction to Multi- and Megavariate Data Analysis using Projection Methods (PCA and PLS). Umetrics AB, Umeä, Sweden, 490 pp).

1. A method to determine viability or non-viability of seeds, wherein
(1) an individual seed or a seed population is analysed by a spectrometric method to provide spectral data; and
(2) the spectral data recorded in (1) are compared with reference spectral data recorded for a reference seed or reference seed population by means of the spectrometric method of (1) and calibrated with reference to viability or non-viability of said reference seed or seed population by means of a calibrating method based on pattern recognition, or said data are compared with reference spectral data from a data base.

2. The method of claim 1, wherein the calibrating method is based on multivariate analysis, megavariate analysis, neural network systems, regression analysis, or vector analysis

3. The method of claim 1 or 2, wherein said individual seed or said seed population is pretreated with water and partially dried before said seed or seed population is analysed in step (1).

4. The method of claim 1, 2 or 3, wherein said spectrometric method comprises irradiation of said seed or seed population with radiation within a wave length range of from about 180 nm to about 2500 nm and measurement of the radiation that is transmitted through or reflected by the irradiated seed or seed population.

5. The method of claim 4, wherein said wavelength range is from about 400 to about 2500 nm and suitably 570-1100 nm.

6. The method of claim 4, wherein said wavelength range is from about 850 to about 1050 nm.

7. The method of any preceding claim, wherein the result from the comparison performed in step (2) is used to classify the seeds or seed populations analysed in step (1) into at least two distinct fractions, one fraction comprising viable seeds and one other fraction comprising non-viable seeds.

8. The method of claim 7, which method further comprises conventional classification of seeds or seed populations in accordance with content, size or colour of the seed or seed population.

9. The method of any preceding claim, wherein the calibrating method is based on multivariate analysis performed by principal components analysis, partial least squares projections to latent structures, target rotation and ridge regression.

10. The method of any preceding claim, wherein the calibrating method is based on regression analysis performed by multilinear regression analysis, linear regression best linear unbiased predictor or best linear unbiased estimator.

11. The method of claim 1, wherein said method comprises the steps of
(I) providing a data base by
(I.a) registering, by means of a spectrometric method, reference spectral raw data of a reference seed or reference seed population;
(I.b) processing the reference spectral raw data to reduce noise and adjust for drift and diffuse light scatter;
(I.c) providing global and local calibration models by calibrating the processed reference spectral data with reference to the known viability or non-viability of the reference seed or reference seed population by performing a data analysis based on pattern recognition, such as multivariate or megavariate analysis, K nearest neighbours, neural networks and linear discriminant analysis; and
(II) registering, by means of said spectrometric method, spectral raw data of a sample seed or sample seed population for which viability or non-viability is to be determined; processing the thereby obtained spectral raw data to reduce noise and adjust for drift and diffuse light scatter; and applying the provided or established calibration model on the processed spectral data in order to determine viability or non-viability of the sample seed or sample seed population.

12. The method of claim 1 or 2, wherein solid particles having similar properties as seeds are determined and separated from the seeds.
